(19) United States
(12) Patent Application Publication
(10) Pub. No.: US 2010/0303040 A1
(43) Pub. Date: Dec. 2, 2010

(54) MOBILE COMMUNICATION TERMINAL

(75) Inventor: Akira TAKAMUNE, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/723,804

(22) Filed: Mar. 15, 2010

(30) Foreign Application Priority Data
May 26, 2009 (JP) P2009-126928

(51) Int. Cl. H04W 36/00; H04W 40/00

(52) U.S. Cl. 370/331; 370/338

(57) ABSTRACT

According to one embodiment, a mobile communication terminal comprises a first section which scans the access points to search for a targeted access point when activated and senses strength of signals received from the access points while scanning, wherein the first section is activated periodically, a second section which performs radio communication after the targeted access point is detected by means of the scanning by the first section, and a controller which specifies the home access point as the targeted access point upon identifying that the mobile communication terminal is out of a service area of the targeted access point from the signal strength sensed by the first section, and supplies the second section with power after the home access point is detected by means of the scanning.

### CROSS REFERENCE TO RELATED APPLICATIONS

This application is based upon and claims the benefit of priority from the prior Japanese Patent Application No. 2009-126928 filed on May 26, 2009;

the entire contents of which are incorporated herein by reference.

### BACKGROUND

1. Field

The present invention relates to a mobile communication terminal.

2. Description of the Related Art

A terminal device complying with a Wake On Wireless LAN system, in a waiting condition, can perform an AP scanning operation for searching for an access point (AP) whose identification information is stored in the terminal device. Upon moving into a service area of an AP and thus detecting the AP by means of the scanning operation, the terminal device can automatically activate other necessary portions of the terminal device and perform a wireless LAN (WLAN) communication process so as to enhance a user's convenience.

For such an automatic activation system, a method for controlling power supply to a mobile communication terminal and a system for the method are disclosed in, e.g., Japanese Patent Publication of Unexamined Applications (Kokai), No. 2006-210993. A mobile communication terminal 1 of JP-A-2006-210993 has a beacon signal perceiving section 102 which works even in a sleeping state. The beacon signal perceiving section 102 has in itself an ESSID (Extended Service Set Identifier) entry list of APs. Upon receiving a beacon signal from an AP, the beacon signal perceiving section 102 identifies whether an ESSID of the AP included in the beacon signal agrees with one of ESSIDs entered in the ESSID entry list. If they agree with each other, the whole mobile communication terminal 1 is automatically activated.

Incidentally, passive scan and active scan systems are known as an AP scan system employed by a mobile communication terminal. According to the passive scan system, the mobile communication terminal obtains a beacon frame coming from a channel of an AP so as to identify an ESSID included in the beacon frame. As the AP conceals the ESSID in some cases, the mobile communication terminal usually sends a request signal by itself to the AP for a scanning operation in accordance with the active scan system.

Then, an active scanning operation will be explained. The AP scanning section of the mobile communication terminal is ready to work in a waiting state. To begin with, the AP scanning section sends Probe Req signals addressed to the AP1 on channels 1-13 in sequence, and waits to receive Probe Resp (1ch)-Probe Resp (13ch) replies which are replies from AP1 on the respective channels.

If the AP scanning section cannot receive the Probe Resp replies, the AP scanning section then sends Probe Req signals addressed to AP2 on the channels 1-13 in sequence, and waits to receive Probe Resp (1ch)-Probe Resp (13ch) replies which are replies from AP2 on the respective channels.

If the mobile communication terminal is out of service areas of the APs, the Probe Resp replies do not come to the mobile communication terminal. Thus, the AP scanning section of the mobile communication terminal repeats a cycle formed by the scans addressed to AP1 on the channels 1-13 and the scans addressed to AP2 on the channels 1-13 twice. If no replies come, the AP scanning section pauses once, and continues similar scanning operations after a certain period of time.

If an AP receives a Probe Req signal from a mobile communication terminal after the mobile communication terminal comes into a service area of the AP, the AP sends a Probe Resp reply signal back on an unused one of the channels 1-13 being available for communication. At the time of receiving the Probe Resp reply and identifying an ESSID of the AP included in the Probe Resp reply, the AP scanning section ends the scanning operation, activates the whole mobile communication terminal and shifts to a procedure for WLAN communication with the AP.

As described above, the AP scanning section of the mobile communication terminal performs a scanning operation for the APs having been entered in the scan target AP list and can activate the mobile communication terminal upon the mobile communication terminal coming into the service area of the entered AP, so as to enhance a user's convenience. From a viewpoint of power saving, however, the mobile communication terminal requires a significant value of power such as currents of 300 mA and of 200 mA per one channel for sending the Probe Req signal and for waiting a reply, respectively. The same power is required for each of the channels 1-13, and the power may further increase in proportion to the number of the APs entered in the scan target AP list. Thus, there is a conflicting problem in that an increase of the number of APs entered in the scan target AP list enhances a user's convenience but causes an increase of power consumption.

### SUMMARY

Exemplary embodiments of the invention provides a mobile communication terminal which comprises a first section which scans the access points to search for a targeted access point when activated and senses strength of signals received from the access points while scanning, wherein the first section is activated periodically, a second section which performs radio communication after the targeted access point is detected by means of the scanning by the first section, and a controller which specifies the home access point as the targeted access point upon identifying that the mobile communication terminal is out of a service area of the targeted access point from the signal strength sensed by the first section, and supplies the second section with power after the home access point is detected by means of the scanning.

### BRIEF DESCRIPTION OF THE DRAWINGS

FIG. 1 shows an exemplary system diagram of WLAN communication of an embodiment.

FIG. 2 is an exemplary block diagram of the mobile communication terminal 100.

FIG. 3A shows an example of screen image displayed on the display section 50 when registering and setting AP data.

FIG. 3B shows an example of the AP list storing section 3 in which various kinds of AP data are registered.

FIG. 4 is a flowchart of an operation of a WLAN setting function 2 of the mobile communication terminal 100.

FIG. 5 is a flowchart of an operation of an activation process function 10 of the mobile communication terminal 100.

FIGS. 6A and 6B are state transition diagrams in which a power supply controller 40 of the mobile communication terminal 100 of the embodiment of the present invention controls power consumption states of other blocks.

### DETAILED DESCRIPTION

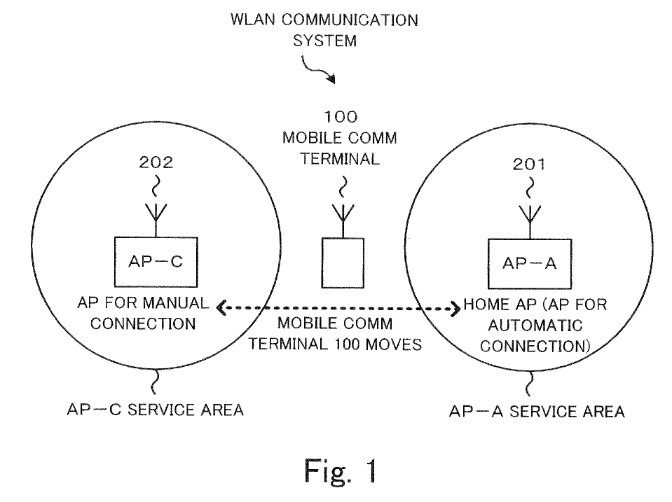

FIG. 1 shows an exemplary system diagram of WLAN communication of an embodiment. FIG. 1 shows two access points AP201 and AP202 as examples, and shows a mobile communication terminal 100 which moves between the two APs. Assume that AP201 (AP-A) is registered in the mobile communication terminal 100 as an AP for automatic activation (home AP). The mobile communication terminal 100 performs an AP scanning operation for AP 201, and automatically activates units and functions to make a wireless communication upon moving into the service area of AP201 (AP-A).

Further, after the mobile communication terminal 100 moves into a service area of AP202 (AP-C), a user can manually connect the mobile communication terminal 100 to AP202 (AP-C) so as to communicate with AP202.

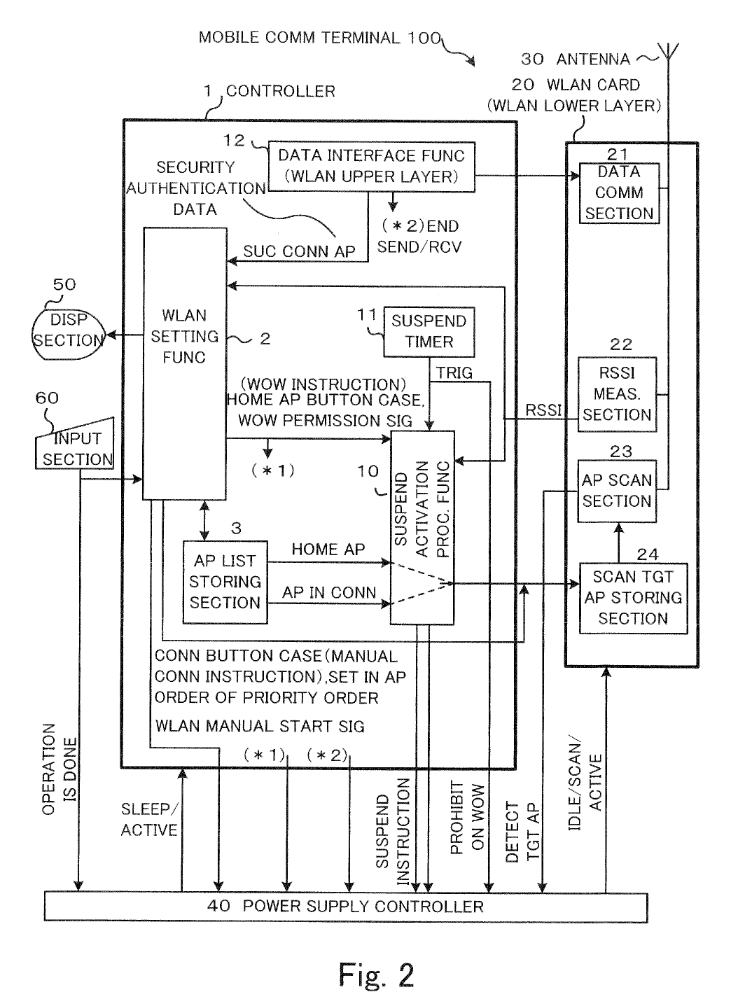

Then, an internal configuration of the mobile communication terminal 100 will be explained. FIG. 2 is an exemplary block diagram of the mobile communication terminal 100. The mobile communication terminal 100 includes a controller 1, a WLAN card 20 (WLAN communication section, WLAN lower layer), an antenna 30, a power supply controller 40, a display section 50, an input section 60 and so on.

(Controller 1)

The controller 1 includes a CPU (Central Processing Unit), a ROM (Read Only Memory), a RAM (Random Access Memory) and so on which are not shown. The controller 1 performs a WLAN setting function 2, a suspend activation process function 10, a data interface function 12 and so forth on the basis of software stored in the ROM. Further, the controller 1 has an AP list storing section 3 and a suspend timer 11.

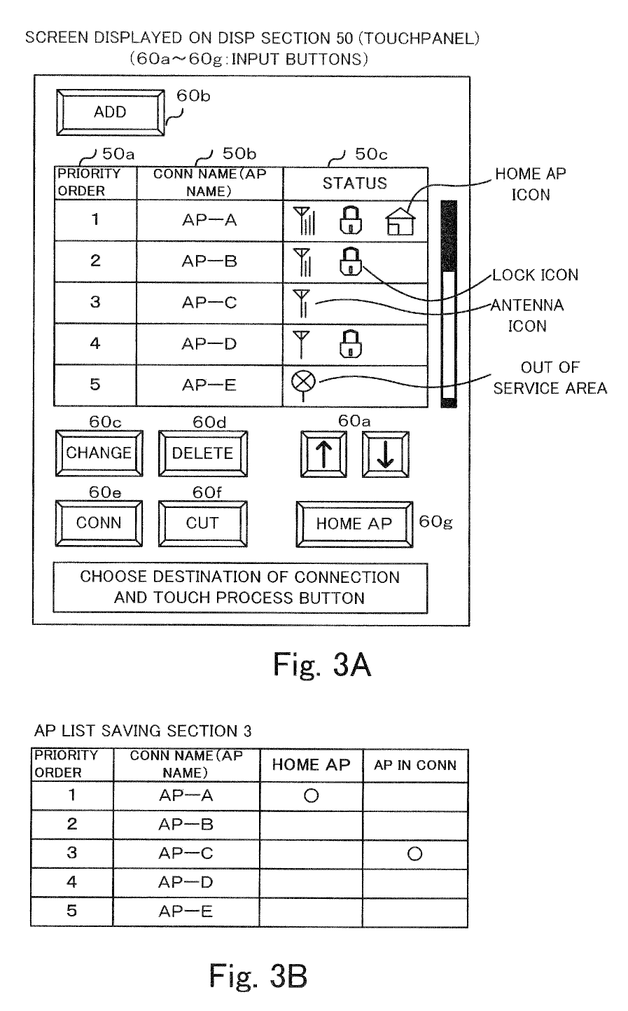

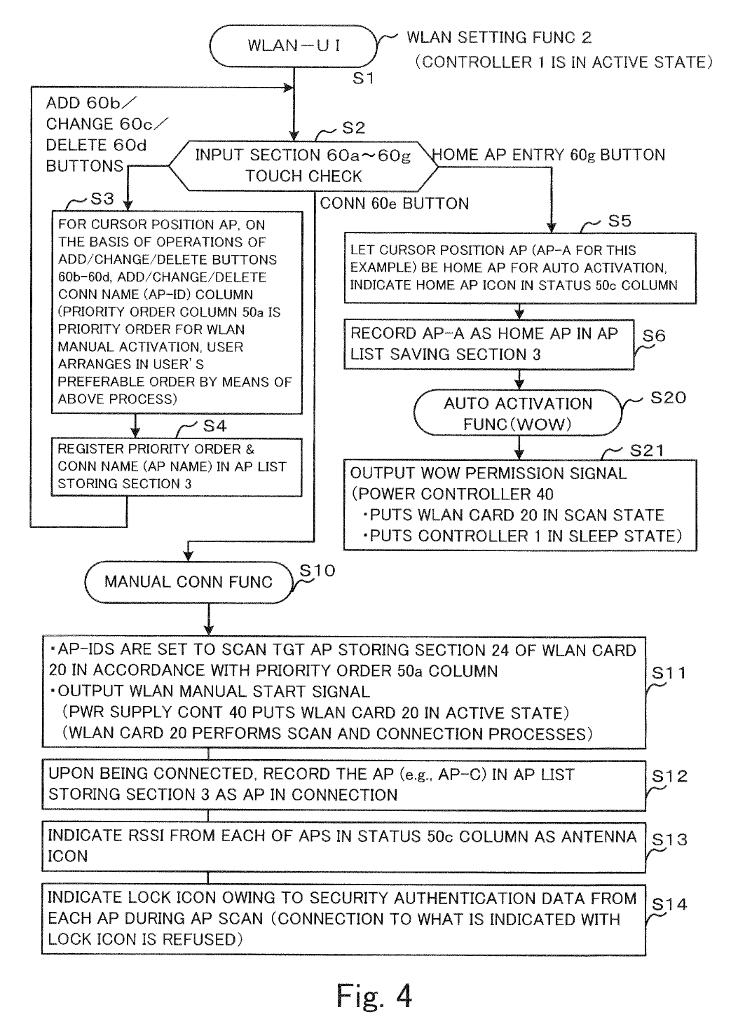

The WLAN setting function 2 registers identification information of APs (hereinafter “AP-ID”) on an AP list and sets one of the AP-IDs as a home AP-ID on the basis of user's operation through the input section 60, as described later in detail with reference to FIGS. 3 and 4. The mobile communication terminal automatically activates units and functions needed to make a wireless communication when detecting the home AP-ID. Further, the WLAN setting function 2 registers an AP-ID as a connected AP in the AP list storing section 3 in response to success information, received from the data communication function 2 and indicating that the AP is successfully connected. Further, the WLAN setting function 2 instructs a WOW (Wake On Wireless) process regarding an automatic activation, instructs a manual connection and so forth on the basis of user's operation.

In case of a manual connection operation, the WLAN setting function 2 stores AP-IDs on the AP list in the AP list storing section 3 into a scan target AP storing section 24 in a WLAN card in sequence so as to let the WLAN card make a WLAN connection.

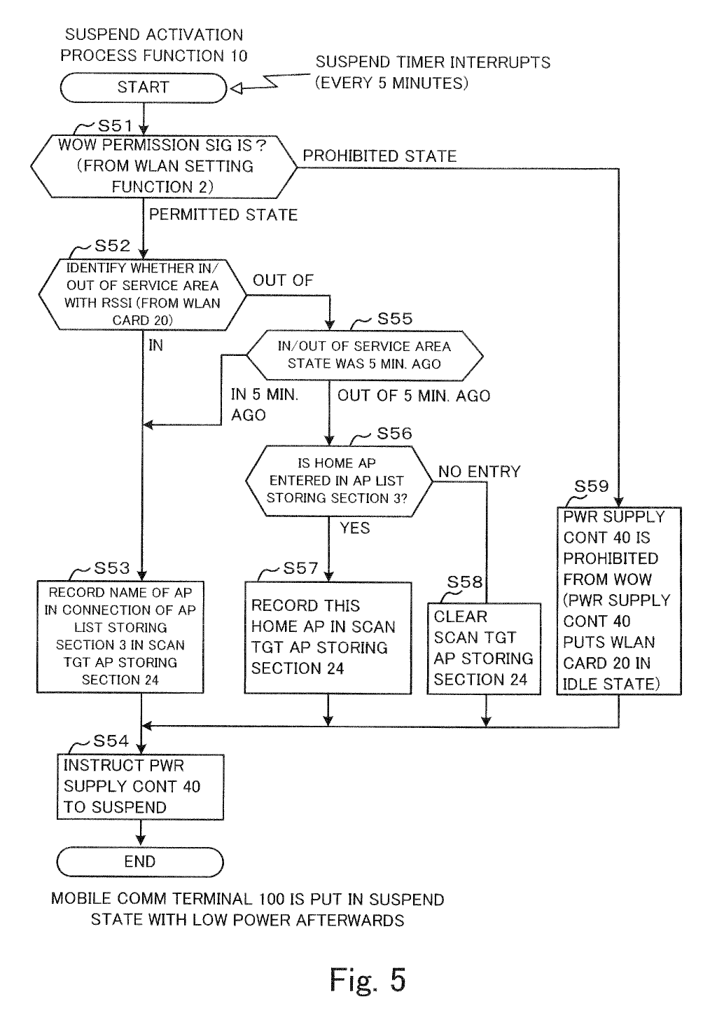

In case of a instructing the WOW process, the activation process function 10 that is periodically activated by the suspend timer 11 estimates a situation and store the home AP-ID in the AP list storing section 3 or an AP-ID of a connected AP into the scan target AP storing section 24. The activation process function 10 will be explained later in detail with reference to FIG. 5.

The data interface function 12 is an upper layer of WLAN communication, and outputs security authentication data from a scanned AP to the WLAN setting function 2. Further, in case that a WLAN connection succeeded, the data interface function 12 outputs the success information including an AP-ID of the AP with which the WLAN connection is established. Further, the data interface function 12 outputs data which indicates an end of communication.

[Wireless LAN Card 20]

The WLAN card 20 is a portion for processing a lower layer of the WLAN communication, and has a data communication section 21, an RSSI (Received Signal Strength Indicator) measuring section 22, an AP scanning section 23, the scan target AP storing section 24 and so on. The antenna 30 sends and receives a radio signal to and from an AP with which the WLAN connection is established.

The scan target AP storing section 24 has an area in which at least one AP-ID being a scan target is registered. In this embodiment, the controller 1 registers only one AP-ID on the scan target AP storing section 24.

The RSSI measuring section 22 measures a received electric field strength value of a radio wave transmitted by an access point, and provides the suspend activation process function 10 of the controller 1 with an RSSI signal.

The AP scanning section 23 scans to search for APs whose AP-IDs are stored in the scan target AP storing section 24. In this embodiment, since only one AP-ID is registered in the scan target AP storing section 24 when searching an AP based on the WOW process, the scanning operation is performed to search for the one AP-ID. Upon detecting the one AP-ID, the AP scanning section 23 provides the power supply controller 40 with a target AP detection signal. The target AP detection signal is used for making the mobile communication terminal 100 ready for the WLAN communication.

The data communication section 21 is activated after the AP scanning section 23 detects an AP whose AP-ID coincides with the AP-ID in the scan target AP storing section 24, and performs a data communication.

Then, a power consumption state of the WLAN card 20 will be explained. The WLAN card 20 can be in three states, i.e., does nothing while consuming almost no power in an idle state, consumes low power in a scan state, and works as a whole in an active state, as controlled by an idle signal, a scan signal, and an active signal coming from the power supply controller 40.

In the idle state, the WLAN card 20 is not supplied with power in a case where WLAN communication is not performed. In the scan state, the RSSI measuring section 22, the AP scanning section 23 and the scan target AP storing section 24 are supplied with power and a scanning operation is performed for an AP-ID. The scan target AP storing section 24 is a nonvolatile memory device. The RSSI measuring section 22, the AP scanning section 23 and the scan target AP storing section 24 which work in the scan state can be integrated in a common IC chip. In the active state, the whole of the WLAN card 20 including the data communication section 21 is supplied with power, and a data communication is performed.

The WLAN card 20 changes over from one to another of the above three states by means of a control of supplying each of the portions with power, and can change over by means of method for prohibiting or allowing an operation of each of the portions. Further, the number of the states is not limited to three, and more states for every one of the portions may be provided. The WLAN card 20 may be replaced by something other than a card, and may be of a built-in type.

The power supply controller 40 which controls the idle, the scan, and the active states of the WLAN card 20 is ready to work at all times.

FIG. 3A shows an example of screen image displayed on the display section 50 when registering and setting AP data FIG. 3B shows an example of the AP list storing section 3 in which various kinds of AP data are registered.

In FIG. 3A, reference numerals 50a to 50c and 60a to 60g indicate an indication only portion and a touchscreen portion, respectively. The display section 50 shows, in this example, a priority order 50a column, a connection name (AP name) 50b column and a status 50c column for five access points.

If a user manually activates WLAN communication, a WLAN manual activation function 5 tries to connect to access points in descending order of the priority order 50a column. The user arbitrarily sets and edits the priority order in the priority order 50a column beforehand by means of the WLAN setting function 2.

The AP name 50b column indicates one or a plurality of access point name(s), each corresponding to an AP-ID (e.g., five names such as AP-A, AP-B, AP-C, AP-D and AP-E) recorded in the AP list storing section 3 (nonvolatile memory). The AP-ID is not shown in FIGS. 3A and 3B, however, the AP-IDs are stored in the AP list storing section 3 in connection with respective access point manes. History of WLAN communication performed with an AP may be registered in the AP list storing section 3. The user may manually register the AP data on the AP list storing section 3.

The status 50c column indicates status data of the individual APs. A home AP icon is indicated in a cell of the AP-A selected as the AP for automatic activation from listed plural APs by means of a user's operation. An antenna icon indicates RSSI information and strength of an RSSI signal coming from the WLAN card 20 is indicated by the number of bars displayed by an antenna image. A lock icon means that an authentication is needed for make a communication with an AP, and displayed in response to security authentication data sent from the AP after an AP scanning operation is performed. The mobile communication terminal 100 cannot communicate with such an AP without a password.

FIG. 3B shows content in the AP list storing section 3. The priority order 50a explained with reference to FIG. 3A, the AP name 50b and the home AP (AP-A) are registered the AP list storing section 3. Further, an AP with which a WLAN connection succeeds, i.e., the AP-C for this example, is registered as the AP in connection.

Then, a process performed by the WLAN setting function 2 will be explained with reference to FIGS. 3A, 3B and 4. FIG. 4 is a flow-chart of an operation of the WLAN setting function 2 of the mobile communication terminal 100. If a user operates for a WLAN communication mode, the WLAN setting function 2 is activated.

The WLAN setting function 2 starts a WLAN-UI (user interface) function first (step S1), and consequently the screen shown in FIG. 3A is displayed. Then, the WLAN-UI function checks whether individual touch buttons 60a-60g are touched (step S2). If a pair of cursor buttons 60a is touched, a cursor (not shown) moves up and down on the columns of the five APs.

Then, at the step S2, new AP data is added into the AP list storing section 3, or the AP data, on which the cursor is located, is changed or deleted on the basis of inputs via an add button 60b, a change button 60c and a delete button 60d (step S3). Since this is an ordinary UI (user interface) operation, therefore its detailed explanation is omitted. Then, the priority order and the AP name are registered in the AP list storing section 3 (step S4).

In step S2, if it is detected that a connection button 60e touched, a manual connection function is made ready to work (step S10). The manual connection function first sets the AP-IDs to the scan target AP storing section 24 of the WLAN card 20 in descending order of the priority order 50a column, and outputs a WLAN manual start signal (step S11). Upon receiving the signal, the power supply controller 40 puts the WLAN card 20 in the active state and the WLAN card 20 performs a scanning operation and a connection process.

When the WLAN setting function 2 receives the success information from the data communication function 12, the WLAN setting function 2 extracts the access point name and the AP-ID, e.g., an AP-C as the access point name and its AP-ID. Then, the WLAN setting function 2 registers the access point name and the AP-ID in the AP list storing section 3 as the AP in connection (step S12).

Further, the WLAN setting function 2 displays the antenna icon corresponding to strength of RSSI signals coming from the WLAN card 20 during a scanning operation in the status 50c column (step S13). The WLAN setting function 2 displays the lock icons in the status 50c column owing to security authentication data coming from the respective APs during the scanning operation (step S14). The lock icons for this example are displayed for AP-A, AP-B and AP-C which refuse a connection without a password.

The WLAN setting function 2 sets an AP for which the cursor is placed when sensing a home AP entry button 60g as being touched as the home AP for automatic activation, which is AP-A for this example. Thus, the WLAN setting function 2 indicates the home AP icon in the status 50c column of AP-A (step S5). The WLAN setting function 2 registers AP-A with its AP-ID as the home AP in the AP list storing section 3 (step S6).

Then, an automatic activation function (the WOW process) is made ready to work (step S20). The automatic activation function outputs a WOW permission signal (step S21). Upon receiving the signal, the power supply controller 40 puts the WLAN card 20 in a scanning state and puts the controller 1 in a sleeping state. The WLAN setting function 2, however, does not directly set the AP-ID of the home AP (AP-A), registered in the AP list storing section 3 by a user, to the scan target AP storing section 24 of the WLAN card 20. A process for setting the AP-ID of the home AP (AP-A) registered in the AP list storing section 3 to the scan target AP storing section 24 of the WLAN card 20 is performed by the suspend process function 10.

The activation process function 10 will be explained, then. FIG. 5 is a flowchart of an operation of the process function 10 of the mobile communication terminal 100. The suspend activation process function 10 is primarily a function for putting the mobile communication terminal 100 in a operation state or a resume state into a suspending state with low power in response to a trigger signal periodically, e.g., every five minutes, output from the suspend timer 11. In addition, the process function 10 in this embodiment serves as a scan target AP controller which controls a dynamic process for setting an AP-ID onto the scan target AP storing section 24 in the WLAN card 20.

The trigger signal is generated by the suspend timer 11 asynchronously with the states of the mobile communication terminal 100, and also, the activation process function 10 is activated asynchronously with the states of the mobile communication terminal 100 whether the mobile communication terminal 100 is in a service area of an AP or not.

Upon being interrupted and activated by the suspend timer 11, the activation process function 10 first checks a WOW permission signal coming from the WLAN setting function 2 (step S51).

If the signal indicates a WOW prohibition state, the activation process function 10 informs the power supply controller 40 that the WOW process is prohibited as the WLAN card 20 does not need to work (step S59). The power supply controller 40 puts the WLAN card 20 in the stop state.

If the signal indicates a WOW permission state at the step S51, the activation process function 10 identifies whether the mobile communication terminal 100 is in or out of an AP service area in accordance with the RSSI signal coming from the WLAN card 20 (step S52). If the mobile communication terminal 100 is in the service area, the suspend activation process function 10 records the AP-ID of the AP in connection on the scan target AP storing section 24 (step S53).

If the mobile communication terminal 100 is out of the service area at the step S52, the activation process function 10 checks a flag (not shown) indicating whether the mobile communication terminal 100 was in or out of the service area five minutes ago to determine whether the mobile communication terminal 100 resides in a border area of an AP (step S55). When the mobile communication terminal 100 resides in the border area, the state of the mobile communication terminal 100 may change between being in the service area and being out of the service area. If the flag indicates that the mobile communication terminal 100 was in the service area five minutes ago, the activation process function 10 identifies the mobile communication terminal 100 as being incompletely out of the service area and shifts to the step S53 for the same process as in the service area. If the flag indicates that the mobile communication terminal 100 was out of the service area five minutes ago, the activation process function 10 identifies the mobile communication terminal 100 as being completely out of the service area, and checks if a home AP for automatic activation is entered by a user in the AP list storing section 3 (step S56). If a home AP is entered, the activation process function 10 registers the AP-ID of the home AP in the scan target AP storing section 24 in the WLAN card 20 (step S57). If no home AP is entered at the step S56, the activation process function 10 clears the scan target AP storing section 24.

That is, the activation process function 10 checks whether the mobile communication terminal 100 is in or out of the service area every time the activation process function 10 is periodically activated by a certain period of time. If the mobile communication terminal 100 is in the service area, the activation process function 10 registers the AP in connection, that the mobile communication terminal 100 is presently connected to, in the scan target AP storing section 24 in the WLAN card 20. If the mobile communication terminal 100 is out of the service area, the activation process function 10 registers the AP-ID of the home AP entered by the user in the scan target AP storing section 24 in the WLAN card 20, as WLAN communication is not being performed.

Thus, the scan target AP storing section 24 in the WLAN card 20 that practically performs a scanning operation can dynamically change over from the home AP entered by the user to the AP in connection that the mobile communication terminal 100 is presently connected to by means of a manual connection, and vice versa.

The activation process function 10 controls the scan target AP storing section 24 in the WLAN card 20 through the steps S53 and S57-S59, and then finally provides the power supply controller 40 with a suspend instruction (step S54) in order to direct the power supply controller 40 to executing a primary suspend process, and ends the process. Upon receiving the suspend instruction, the power supply controller 40 puts the mobile communication terminal 100 in a suspend state with low power

The activation process function 10 is primarily a function that periodically works. The activation process function 10 can identify whether the mobile communication terminal 100 is in or out of a service area by periodically working in accordance with the present invention. Thus, the activation process function 10 controls a dynamic process for setting an AP-ID onto the scan target AP storing section 24 in the WLAN card 20.

Although the activation process function 10 checks whether the mobile communication terminal 100 was in or out of the service area five minutes ago at the step S55, this part of the process can be deleted and the process can shift from the out-of-service branch of the step S2 to the step S56.

Assume that the mobile communication terminal 100 moves in a service area of a home AP for automatic activation entered by a user, in a service area of another AP for manual activation, and out of both of the service areas in FIG. 1. How the mobile communication terminal 100 works in such a case in accordance with the process described above will be explained. Assume that the user enters AP-A as the home AP with its AP-ID in the AP list storing section 6 in advance. Assume further that, immediately after the power is turned on to be supplied to the mobile communication terminal 100, the AP-ID of the home AP (AP-A) in the AP list storing section 6 is set onto the scan target AP storing section 24 in the WLAN card 20 by default.

If the power is turned on to be supplied to the mobile communication terminal 100 in the service area of AP-A, the WOW function is activated for AP-A saved in the scan target AP storing section 24, AP-A is detected by means of a scanning operation and the whole mobile communication terminal 100 is automatically activated.

If the mobile communication terminal 100 moves to the outside of the service area, the activation process function 10 registers the AP-ID of the home AP (AP-A) in the scan target AP storing section 24 in the WLAN card 20, and the WLAN card 20 performs a scanning operation for the home AP (AP-A). As a matter of course, the activation process function 10 cannot detect the home AP (AP-A).

If the mobile communication terminal 100 moves into the service area and a user manually performs WLAN communication, a WLAN connection operation is performed in the priority order of the AP list storing section 3, and the mobile communication terminal 100 is consequently connected to AP-C. Then, the AP-C as the AP name and its AP-ID is recorded in the AP list storing section 3 as the AP in connection.

The suspend activation process function 10 periodically occurs. Upon occurring often in the AP-C service area, the activation process function 10 detects the mobile communication terminal 100 in the service area, records the AP in connection (AP-C) registered in the AP list storing section 3 in the scan target AP storing section 24 so as to continue the communication with AP-C.

Then, if the mobile communication terminal 100 moves to the outside of the service area, the mobile communication terminal 100 performs the above process for the outside of the service area.

According to the present invention, as the WLAN card 20 performs a scanning operation for just one scan target AP so that power consumption for the scanning operation can be reduced. In order to compensate for user's inconvenience caused by setting just one AP, the activation process function 10 which is periodically activated by a certain period of time registers the home AP set by the user in the scan target AP storing section 24 in the WLAN card 20 again while the mobile communication terminal 100 is out of the service area. Thus, the user need not reenter the home AP, so that enhanced convenience can be enjoyed.

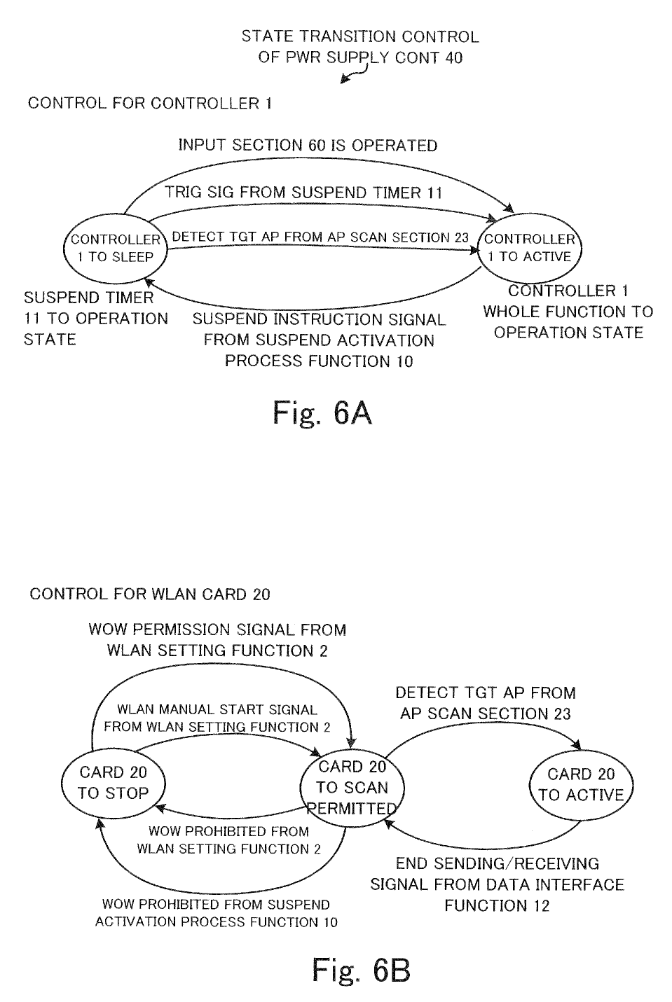

Then, functions of the power supply controller 40 will be explained. FIGS. 6A and 6B are state transition diagrams in which the power supply controller 40 of the embodiment of the present invention controls power consumption states of other blocks. An operation of the power supply controller 40 will be explained also with reference to FIG. 2. As not being a main portion of the present invention, it will be simply explained. All transition factors are not shown on input/output signals to/from the power supply controller 40 shown in FIG. 2 or in FIG. 6.

FIG. 6A is a state transition diagram in which the power supply controller 40 changes the controller 1 from a sleeping state to an active state and vice versa.

One of factors of a transition of the controller 1 from the sleeping state to the active state made by the power supply controller 40 is an “operation is done” signal from the input section 60, which allows the WLAN setting function 2 related to the input section 60 to work. Second one of the factors is the trigger signal provided by the suspend timer 11 every certain period of time, which allows the related suspend activation process function 10 to work. Third one of the factors is a target AP detection signal from the AP scanning section 23, which allows the data interface function 12 to work for sending and receiving data for performing a process on the WLAN upper layer after the target AP is detected by means of a scanning operation.

One of factors of a reverse transition of the controller 1 from the active state to the sleeping state made by the power supply controller 40 is a suspend instruction signal from the suspend activation process function 10, which makes the controller 1 shift to the sleeping state every certain period of time.

FIG. 6B is a state transition diagram in which the power supply controller 40 changes three states of the WLAN card 20, i.e., a stop state, a scan state and an active state, to and from one another.

One of factors of a transition of the WLAN card 20 from the stop state to the scan state made by the power supply controller 40 is a WOW setting permission signal from the WLAN setting function 2, which allows a scanning operation of the WLAN card 20 to work for Wake On Wireless LAN. Second one of the factors is a ban on WOW from the WLAN setting function 2 in a case where, e.g., a user deletes a home AP entry.

First one of factors of a reverse transition of the WLAN card 20 from the scan state to the stop state made by the power supply controller 40 is the ban on WOW from the WLAN setting function 2, which makes the WLAN card 20 stop. Second one of the factors is a ban on WOW from the activation process function 10, which is a primary signal for suspend activation.

A factor of a transition of the WLAN card 20 from the scan state to the active state made by the power supply controller 40 is a target AP detection signal from the AP scanning section 23, which allows the whole mobile communication terminal 100 to work.

A factor of a reverse transition of the WLAN card 20 from the active state to the scan state made by the power supply controller 40 is an end of sending/receiving signal from the data interface function 12, which makes the WLAN card 20 return to the scan state.

According to the embodiment of the present invention, the activation process function 10 which is activated every certain period of time performs the above process. Instead, e.g., the WLAN manual activation function 5 may check an end of a WLAN communication process that was manually activated and may record the home AP recorded in the AP list storing section 3 into the scan target AP storing section 24 after the end.

Further, although just one AP is recorded in the scan target AP storing section 24 in the WLAN card 20 so that power can be saved, two APs may be made targets of a scanning operation for automatic activation and a manually connected AP may be changed over to one of the two APs for a user's convenience.

Further, the AP scanning section 23 unconditionally performs a scanning operation for all APs registered in the scan target AP storing section 24. In addition, a second scan target AP storing section may be provided, and an AP for the WOW process and an AP for manual connection may be saved in the first scan target AP storing section 24 and the second scan target AP storing section, respectively, and the controller 1 may direct the WLAN card 20 to use which of the scan target AP storing sections.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication terminal connectable to access points, comprising:
a first section which scans the access points to search for a targeted access point when activated and senses strength of signals received from the access points while scanning, wherein the first section is activated periodically;
a second section which performs radio communication after the targeted access point is detected by means of the scanning by the first section; and
a controller which specifies the home access point as the targeted access point upon identifying that the mobile communication terminal is out of a service area of the targeted access point from the signal strength sensed by the first section, and supplies the second section with power after the home access point is detected by means of the scanning.

2. The mobile communication terminal according to claim 1 further comprising an operation section, wherein the scanning and the radio communication can be manually performed in accordance with an operation done on the operation section upon the targeted access point is different from the home access point.

3. The mobile communication terminal according to claim 1, wherein the controller has a list of the access points indicating which ones of the access points are the targeted access point and the home access point.

4. The mobile communication terminal according to claim 2, wherein the controller has a list of the access points indicating an order of the access points, and the scanning operation can be manually performed in accordance with the order.

5. The mobile communication terminal according to claim 1, wherein the controller has a list of the access points indicating which ones of the access points needs a password for performing the radio communication owing to authentication data received from the access points during the scanning operation.

6. The mobile communication terminal according to claim 1 further adapted for being suspended, wherein the first section is periodically activated in synchronization with a return from a suspended state.

7. The mobile communication terminal according to claim 1, wherein the controller identifies that the mobile communication terminal is out of the service area of the targeted access point upon the signal strength sensed by the first section being repeatedly less than a threshold.

8. A mobile communication terminal having a WLAN communication section and a controller, the WLAN communication section comprising:
a scan target access point storing section which stores a scan target access point data; and
an access point scanning section which scans the access point based on the scan target access point data in the scan target access point storing section,
and the controller comprising:
a home access point storing section which stores a home access point data for automatic activation;
an automatic activation controller which directs the WLAN communication section to scan;
an access point list storing section which stores an access point;
an access point in connection storing section which, in case of a successful connection to an access point, stores the access point data;
a manual connection controller which writes the access point data in the access point list storing section into the scan target access point storing section so as to direct the WLAN communication section to scan, the manual connection controller being adapted for registering a connected access point data in the access point in connection storing section;
a scan target access point controller which writes the home access point data in the home access point storing section into the scan target access point storing section while no WLAN communication is being performed, the scan target access point controller being adapted for writing the access point in the access point data in connection saving section into the scan target access point storing section while WLAN communication is being performed.

9. A mobile communication terminal having a WLAN communication section and a controller, the WLAN communication section comprising:
a scan target access point storing section which stores a scan target access point data;
an access point scanning section which scans the access point stored in the scan target access point storing section so as to detect the access point; and
a received electric field strength measuring section which measures received electric field strength of a transmitted wave from an access point, and outputs a received electric field strength signal to the scan target access point storing section,
and the controller comprising:
a home access point storing section which stores a home access point data for automatic activation;
an automatic activation controller which directs the WLAN communication section to scan;
an access point list storing section which stores an access point;
an access point in connection storing section which, in case of a successful connection to an access point, stores the access point data;
a timer which produces a timing signal for setting the mobile communication terminal to a suspend state of low power consumption every certain period of time;
a scan target access point controller which is activated by the timer every certain period of time, the scan target access point controller being adapted for writing the home access point data in the home access point storing section into the scan target access point storing section upon the received electric field strength signal being in an in-service-area state for an identification threshold, the scan target access point controller being adapted for writing the access point in the access point data in connection storing section into the scan target access point storing section upon the received electric field strength signal being in an out-of-service-area state for the identification threshold.

10. The mobile communication terminal according to claim 8, wherein
at least one access point data is registered with a specified priority order in the access point list storing section, and
the manual connection controller writes the plural access point data in the access point list storing section into the scan target access point storing section in accordance with the priority order, and directs the WLAN communication section to scan.

11. The mobile communication terminal according to claim 9, wherein the out-of-service-area state is a case where the electric field strength signal remains in the out-of-service-area state for the identification threshold for a certain period of time.

12. The mobile communication terminal according to claim 9, wherein
the scan target access point controller further provides a suspend directing signal for putting the mobile communication terminal in a suspend state of low power consumption, and
the mobile communication terminal further comprises a power supply controller which puts the mobile communication terminal in a resume state which is a state in operation upon the access point scanning section detecting an access point, the power supply controller being adapted for putting the mobile communication terminal in the suspend state upon receiving the suspend directing signal from the scan target access point controller.
